(19) United States
(12) Patent Application Publication
(10) Pub. No.: US 2026/0169353 A1
(43) Pub. Date: Jun. 18, 2026

(54) OPTICAL APPARATUS, IMAGE PICKUP APPARATUS, AND IMAGING SYSTEM

(71) Applicant: CANON KABUSHIKI KAISHA, Tokyo (JP)

(72) Inventor: KATSUHIKO NAGATA, Saitama (JP)

(21) Appl. No.: 19/398,154

(22) Filed: Nov. 24, 2025

(30) Foreign Application Priority Data
Dec. 12, 2024 (JP) 2024-217642

(51) Int. Cl. G03B 7/18; G02B 5/00; G03B 7/08; G03B 7/20; H04N 23/55; H04N 23/75

(52) U.S. Cl. CPC G03B 7/18; G02B 5/005; G03B 7/08; G03B 7/20; H04N 23/55; H04N 23/75

(57) ABSTRACT

An optical apparatus attachable to and detachable from an image pickup apparatus includes an aperture stop configured to change an aperture value, a first optical member configured to change an aberration by being inserted into and removed from an optical path, one or more memories storing instructions, and one or more processors that, upon execution of the instructions, operate to perform processing regarding the aperture stop in accordance with a first aperture value that limits a variable range of the aperture value, and a second aperture value transmitted from the image pickup apparatus. The first aperture value is determined based on an optical characteristic of the first optical member.

### BACKGROUND

### Field of the Technology

The aspect of the disclosure relates to one or more embodiments of a lens apparatus, an image pickup apparatus, and an imaging system.

### Description of the Related Art

Japanese Patent Application Laid-Open No. 2000-162692 discloses a configuration for controlling an iris to prevent the problem of screen brightness fluctuating after switching an optical member that changes magnification. A lens apparatus has recently been proposed that includes an optical member that can change aberrations to create a blur effect like that viewed in cinematic images.

### SUMMARY

One or more embodiments of an optical apparatus according to one or more aspects of the disclosure may be attachable to and detachable from an image pickup apparatus and include an aperture stop configured to change an aperture value, a first optical member configured to change an aberration by being inserted into and removed from an optical path, one or more memories storing instructions, and one or more processors that, upon execution of the instructions, operate to perform processing regarding the aperture stop in accordance with a first aperture value that limits a variable range of the aperture value, and a second aperture value transmitted from the image pickup apparatus. The first aperture value is determined based on an optical characteristic of the first optical member.

One or more embodiments of an image pickup apparatus according to one or more aspects of the disclosure may be attachable to and detachable from an optical apparatus that includes an aperture stop and a first optical member configured to change an aberration and include an image sensor, one or more memories storing instructions, and one or more processors that, upon execution of the instructions, operate to acquire a first aperture value that defines a movable range of the aperture stop, which is determined based on an optical characteristic of the first optical member, and adjust an exposure amount to the image sensor. In a case where the first aperture value is acquired, the one or more processors operate to set an aperture value for the aperture stop to the first aperture value, and switch an exposure adjustment method from a first method to a second method.

An imaging system including the above optical apparatus or image pickup apparatus also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of an imaging system according to a first embodiment.

FIG. 2 illustrates a relationship between an in-focus level (effect ratio) and a focus lens position.

FIGS. 3A and 3B illustrate a control value for an iris and its content display.

FIG. 4 is a flowchart illustrating processing of a determining unit and a variable neutral density filter (VND) setting information creator according to the first embodiment.

FIG. 5 is a configuration diagram of an imaging system according to a second embodiment.

FIG. 6 illustrates a relationship between an in-focus level (effect ratio) and a focus lens position.

FIG. 7 illustrates a controllable range of the iris relative to an effect ratio.

FIG. 8 is a flowchart illustrating processing of a determining unit and a VND setting information creator according to the second embodiment.

FIG. 9 is a configuration diagram of an imaging system according to the third embodiment.

FIGS. 10A and 10B illustrate an iris control value and a VND setting value.

FIG. 11 is a flowchart illustrating processing of a determining unit and a VND setting information creator according to a third embodiment.

FIG. 12 is a configuration diagram of an imaging system according to a fourth embodiment.

FIG. 13 is a flowchart illustrating lens processing according to the fourth embodiment.

FIG. 14 is a flowchart illustrating camera processing according to the fourth embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

### First Embodiment

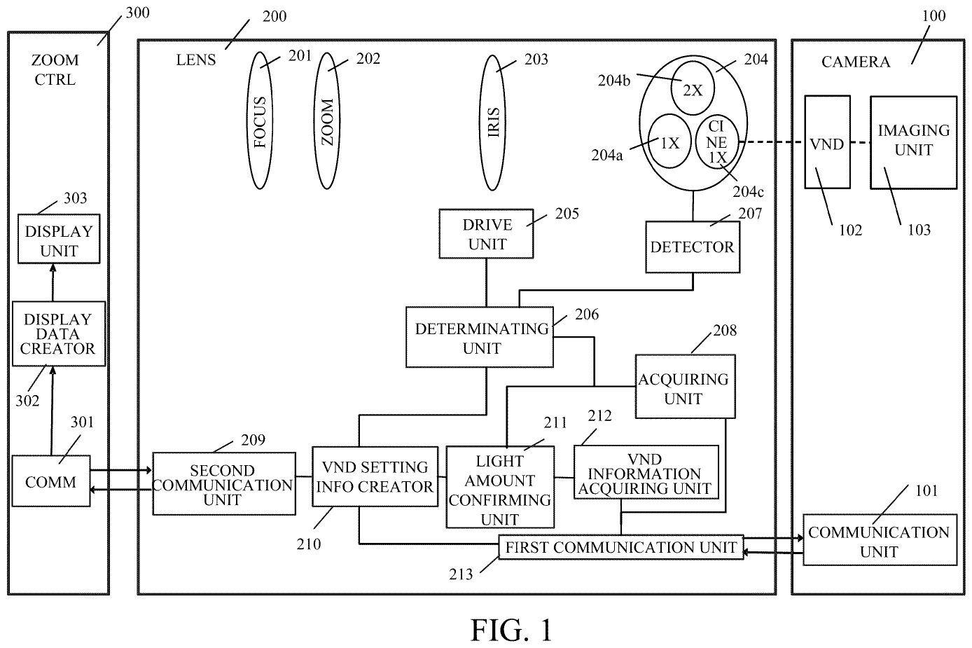

FIG. 1 is a block diagram of an imaging system (camera system) according to this embodiment. The imaging system includes a camera (image pickup apparatus) 100, a lens (lens apparatus) 200, and a zoom controller (CTRL) 300. The camera 100 is configured to accommodate the lens 200. The lens 200 is connected to the zoom controller 300 and the camera 100 for use.

The camera 100 includes a communication unit (acquiring unit) 101, a variable neutral density filter (VND) 102, and an imaging unit 103. The communication unit 101 communicates with a first communication unit 213 included in the lens 200. Communication between the first communication unit 213 and the communication unit 101 transmits and receives information about the camera 100 and lens 200, such as information about the iris 203 and the setting value of the VND 102. The VND 102 can variably set the attenuation amount of the light amount.

The lens 200 includes an optical system configured to form an object image. The optical system includes a focus lens 201, a zoom lens 202, an iris (aperture stop) 203 (configured to change an aperture value), and an extender turret (driven unit) 204. The focus lens 201, the zoom lens 202, the iris 203, and the extender turret 204 are driven electrically, and light passing through the optical system forms the optical image on the imaging surface of the image sensor included in the imaging unit 103.

The extender turret 204 includes a plurality of optical members 204a (1x), 204b (2x), and 204c (CINE 1x). By rotating the extender turret 204, the plurality of optical members 204a, 204b, and 204c are inserted into and removed from the optical path.

The optical members 204a and 204b are normal lenses (second optical members) designed to change the magnification. The optical members 204a and 204b are changed to different magnifications (here, 1x and 2x). The optical member 204c is a soft focus lens (first optical member, soft focus lens, cinema lens) designed to change aberration by being inserted into and removed from an optical path. By changing the aberration, a soft focus lens can impart a cinematic blur effect (softening the focus and widening the focus range). That is, in a case where a soft focus lens is inserted into the optical path, the object can be illustrated with a soft atmosphere while being in focus. Here, changing the aberration means, for example, intentionally creating spherical aberration or chromatic aberration. The disclosure is not limited to this example, and aberrations other than spherical aberration and chromatic aberration may also be intentionally created. However, to achieve a better effect on the object, at least one of spherical aberration and chromatic aberration may be provided.

The optical member provided in the extender turret 204 may be different from those provided in this embodiment. For example, the optical member 204a may include a soft focus lens that attempts to change the aberration as in the optical member 204c, as well as changing the magnification differently from that of the optical member 204c.

In this embodiment, at least one soft focus lens may be inserted into the optical path. In a case where a single soft focus lens is provided, that single soft focus lens may always be inserted into the optical path.

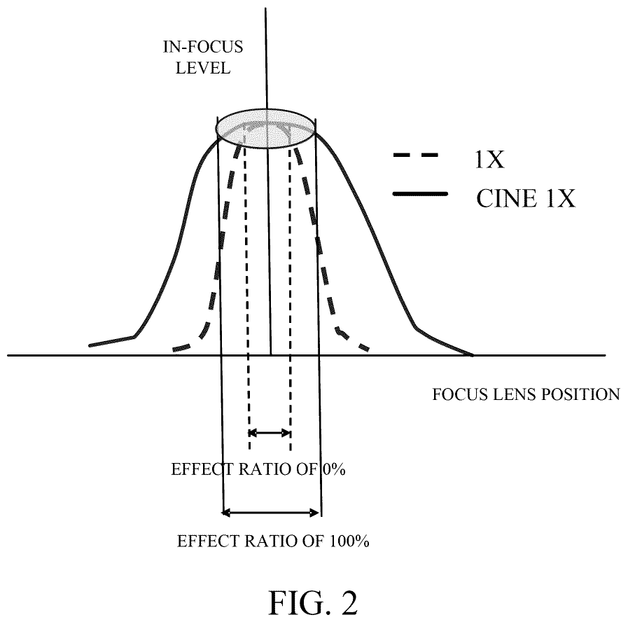

FIG. 2 illustrates the in-focus level (or degree) in a case where the optical members 204a and 204c are inserted into the optical path. A horizontal axis represents the position of the focus lens 201, and a vertical axis represents the in-focus level. The optical member 204c has the effect of widening the peak range of the in-focus level compared to optical member 204a. However, to achieve this effect, it is necessary to limit a movable range of the iris 203 to a controllable range from OPEN (maximum or full aperture value, open F-number) to limited Fno (first aperture value (that limits a variable range of the aperture value)). In this embodiment, in a case where the optical member 204c is inserted into the optical path, the effect can be achieved by controlling the iris 203 within the controllable range. The limited Fno is determined based on the effect imparted in accordance with the aberration changed by the optical member 204c (or based on an optical characteristic of the first optical member).

The lens 200 further includes a drive unit 205, a determining unit (control unit) 206, a detector 207, an acquiring unit 208, a second communication unit 209, a VND information acquiring unit 212, and the first communication unit 213. The drive unit 205 includes a drive circuit motor, an encoder, and a position generation unit, and drives the iris 203. The determining unit 206 determines a control value for the iris 203 and defines the controllable range. The control unit includes one or more memories storing instructions, and one or more processors that, upon execution of the instructions, operate to serve as all or a part of the determining unit 206, the acquiring unit 208, a VND setting information creator 210, a light amount confirming unit 211, a VND information acquiring unit 212, and other units. The detector 207 detects whether the optical member 204c is inserted into or removed from the optical path. The acquiring unit 208 acquires an instruction value (second aperture value (transmitted from the image pickup apparatus)) for the iris 203 from the camera 100. The determining unit 206 determines a control value for the iris 203 according to the instruction value for the iris 203 from the camera 100, and controls the iris 203 via the drive unit 205 using the determined control value for the iris 203. The VND information acquiring unit 212 acquires a setting value for the VND 102.

The lens 200 includes the VND setting information creator 210 and the light amount confirming unit 211. The light amount confirming unit 211 calculates and confirms (monitors) a light amount currently set in the camera 100 from the setting value for the VND 102 and the instruction value for the iris 203 from the camera 100. In a case where the instruction value for the iris 203 from the camera 100 differs from the control value for the iris 203 determined by the determining unit 206, the VND setting information creator 210 calculates a setting value for the VND 102 that will be the same as the light amount confirmed by the light amount confirming unit 211.

The zoom controller 300 includes a communication unit (COMM) 301, a display data creator 302, and a display unit 303. The communication unit 301 communicates with the second communication unit 209 of the lens 200. The display data creator 302 creates display data using data obtained from the communication unit 301 and displays it on the display unit 303.

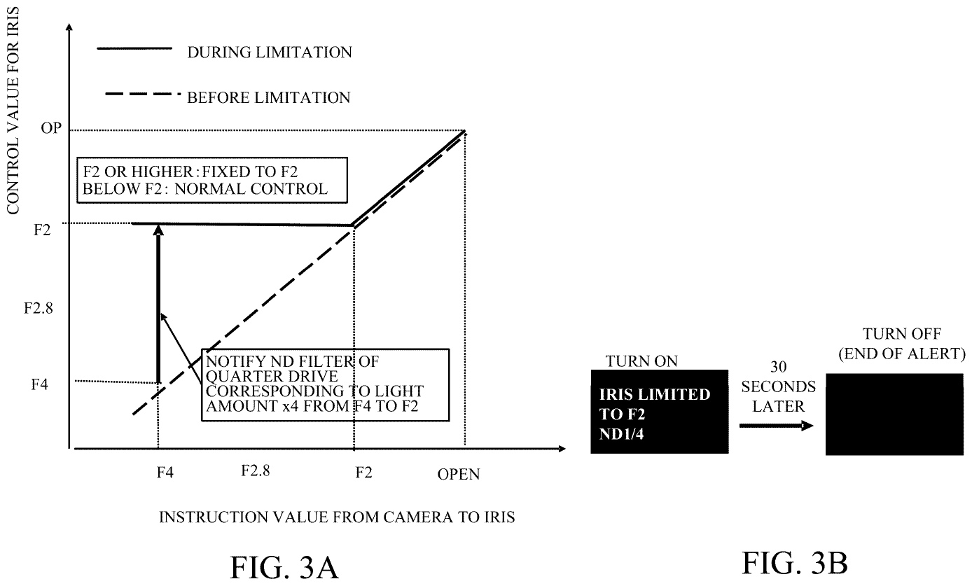

FIGS. 3A and 3B illustrate a control value for the iris 203 and its content display in a case where the optical member 204c is inserted into the optical path.

FIG. 3A explains the control value for the iris 203 in a case where the optical member 204c is inserted into the optical path. In FIG. 3A, the horizontal axis represents an instruction value for the iris 203 from the camera 100, and a vertical axis represents a control value of the iris 203 determined by the determining unit 206. In FIG. 3A, a limited Fno that defines the controllable range of the iris 203 which can achieve the effect of the optical member 204c is set to F2. In a case where the instruction value for the iris 203 of the camera 100 is between F4 and F2, the determining unit 206 sets the control value for iris 203 to F2. In a case where the instruction value for the iris 203 of the camera 100 is F4 and the determining unit 206 sets the control value for the iris 203 to F2, the light amount from the iris 203 becomes four times greater, so the VND setting information creator 210 calculates the setting value for the VND 102 to be one-quarter as large as the current value. In a case where the instruction value for the iris 203 from the camera 100 is smaller than F2 (F2 to OP), the determining unit 206 sets the control value for the iris 203 to the instruction value for the iris 203 of the camera 100.

FIG. 3B illustrates the limited Fno displayed on display unit 303 of the zoom controller 300 for a certain period of time (30 seconds in this case) in a case where the optical member 204c is inserted into the optical path, and the setting value to be set for the VND 102 of the camera 100. Thereby, the user can recognize that the limited Fno of the iris 203 is F2, and can be prevented from forgetting to set the VND 102.

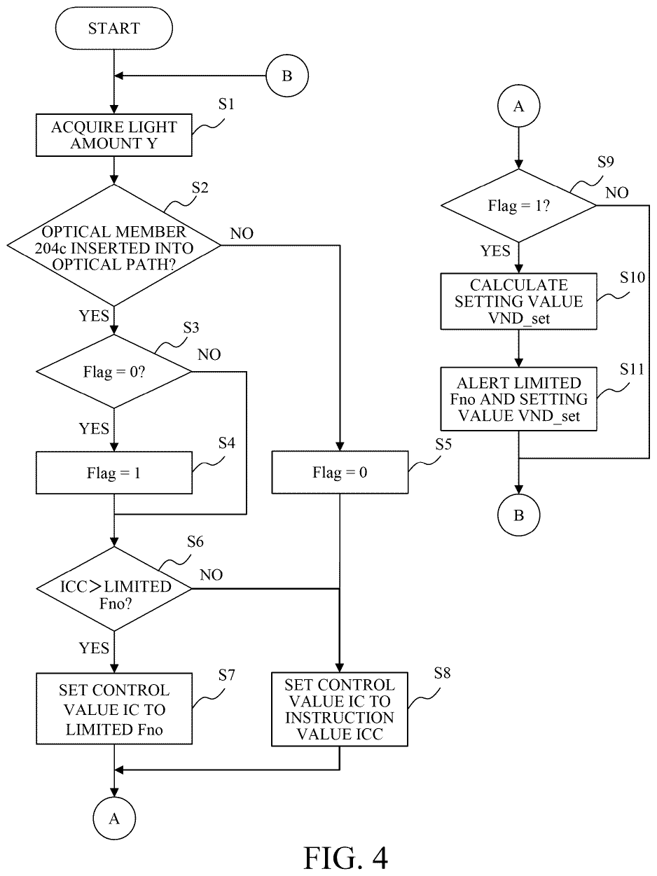

FIG. 4 is a flowchart illustrating the processing of the determining unit 206 and VND setting information creator 210 according to this embodiment.

In step S1, the VND setting information creator 210 acquires a light amount Y (exposure amount of the image pickup apparatus at the second timing) calculated using the instruction value ICC for the iris 203 from the camera 100 and the setting value for the VND 102.

In step S2, the determining unit 206 determines whether the optical member 204c has been inserted in the optical path. In a case where the determining unit 206 determines that the optical member 204c has been inserted into the optical path, it executes the processing of step S3, and in a case where it determines that the optical member 204c has not been inserted into the optical path, it executes the processing of step S5.

In step S3, the determining unit 206 determines whether the variable Flag, which is used to check whether the optical member 204c has just been inserted, is 0. In a case where the determining unit 206 determines that the variable Flag is 0, it executes the processing of step S4, and in a case where it determines that the variable Flag is not 0, it executes the processing of step S6.

In step S4, the determining unit 206 sets the variable Flag to 1.

In step S5, the determining unit 206 sets the variable Flag to 0.

In step S6, the determining unit 206 determines whether the instruction value ICC is greater than the limited Fno. In a case where the determining unit 206 determines that the instruction value ICC is greater than the limited Fno, it executes the processing of step S7, and in a case where it determines that the instruction value ICC is not greater than the limited Fno, it executes the processing of step S8.

In step S7, the determining unit 206 sets the control value IC for the iris 203 to the limited Fno.

In step S8, the determining unit 206 sets the control value IC for the iris 203 to the instruction value ICC.

In step S9, the determining unit 206 determines whether the variable Flag is 1. In a case where the determining unit 206 determines that the variable Flag is 1, it executes the processing of step S10, and in a case where it determines that the variable Flag is not 1, it executes the processing of step S1.

In step S10, the VND setting information creator 210 calculates the setting value VND_set of the VND 102 for the control value IC so that the current light amount (exposure amount of the image pickup apparatus at the first timing) becomes the light amount Y.

In step S11, the VND setting information creator 210 alerts (notifies or transmits) the zoom controller 300 to the limited Fno and setting value VND_set.

As described above, the configuration according to this embodiment can properly execute processing in a case where an optical member that changes the aberration is used.

In this embodiment, in a case where the instruction value ICC is greater than the limited Fno, the movable range of the iris 203 is limited to the controllable range, but an alert may be simply displayed on the display unit 303.

In this embodiment, the alert (notification) is sent to the zoom controller (operation apparatus) 300, but the alert may also be sent to another external device. For example, the alert may be sent to the camera (image pickup apparatus) 100, and the limited Fno and VND 102 may be set by the camera 100.

In this embodiment, the setting value of VND 102 is alerted as information regarding exposure adjustment, but values regarding the iris, image gain, and shutter speed provided in the camera 100 may also be alerted.

### Second Embodiment

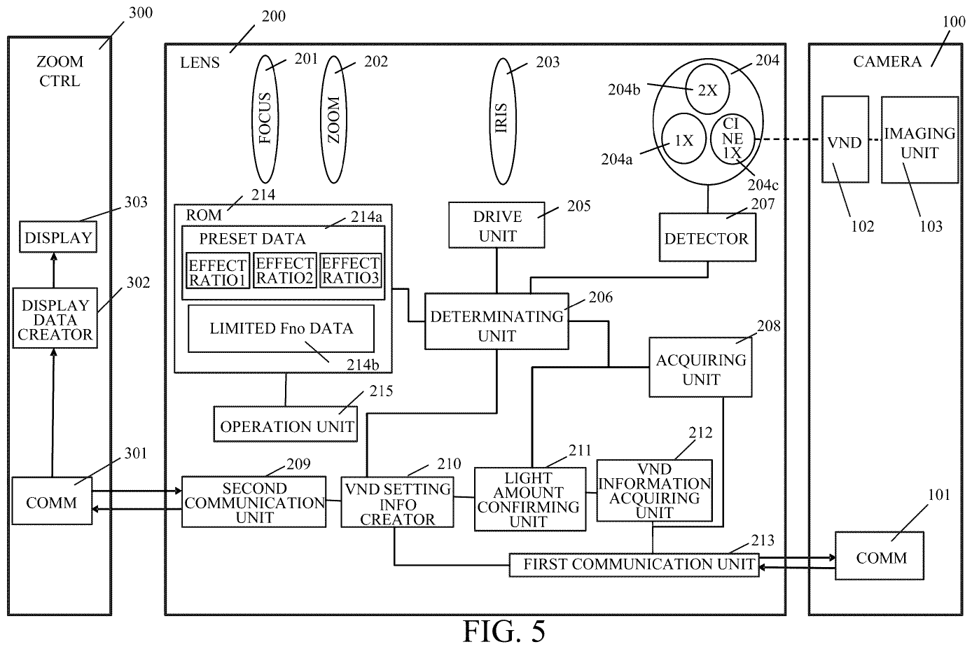

FIG. 5 illustrates the configuration of an imaging system according to this embodiment. This embodiment will discuss only the configuration that differs from that of the first embodiment, and will omit a description of the common configuration.

The lens 200 according to this embodiment includes, in addition to the configuration of the first embodiment, a ROM 214, which is a nonvolatile memory, and an operation unit 215. The ROM 214 stores preset data 214a regarding an effect ratio (a value between 0% and 100%) that indicates the degree of effect obtained by the optical member 204c, which will be described later. Multiple preset data 214a can be set. The ROM 214 also stores limited Fno data 214b, which is a data table of the limited Fno for the iris 203 required for the effect ratios of 0% to 100%. The operation unit 215 is used in a case where the user selects a preset value from the preset data 214a.

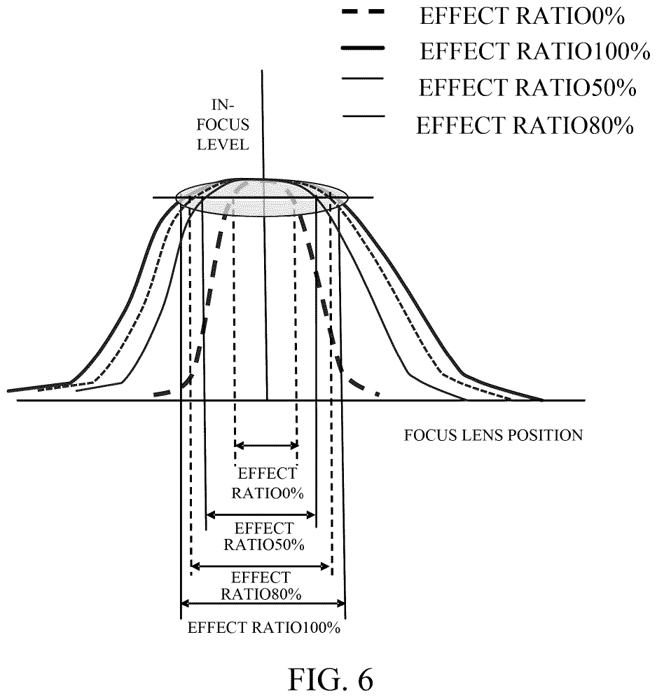

FIG. 6 illustrates a relationship between the in-focus level (and effect ratio) and the focus lens position. An effect ratio of 100% means that the effect of widening the in-focus level is maximum, and the control value for the iris 203 at this time is OPEN.

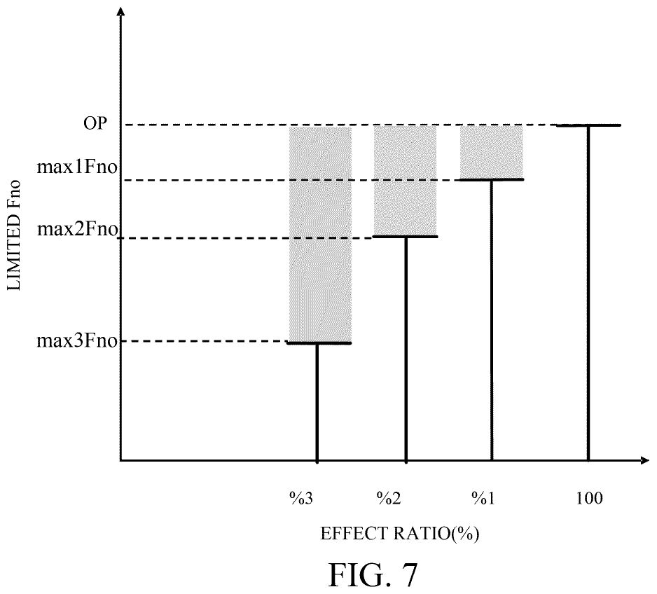

FIG. 7 illustrates a controllable range of the iris 203 relative to the effect ratio. In FIG. 7, a horizontal axis represents the effect ratio, and a vertical axis represents the limited Fno. %1, %2, and %3on the horizontal axis are preset values set by the user using the operation unit 215. The data (%1, max1Fno), (%2, max2Fno), and (%3, max3Fno) in FIG. 7 are determined by reading them from the limited Fno data 214b.

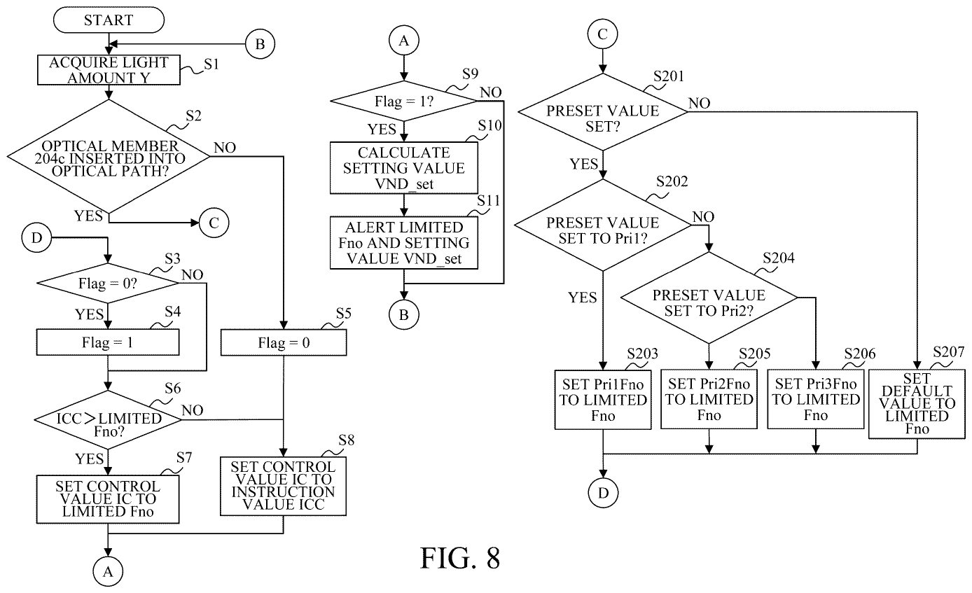

FIG. 8 is a flowchart illustrating the processing of the determining unit 206 and VND setting information creator 210 according to this embodiment. Here, the preset data 214a includes three preset values Pri1, Pri2, and Pri3, and the user can set one of the three preset values using the operation unit 215.

The processing of step S1 is similar to the processing described in the first embodiment, so a description thereof will be omitted. In step S2, the determining unit 206 determines whether the optical member 204c has been inserted into the optical path. In a case where the determining unit 206 determines that the optical member 204c has been inserted into the optical path, it executes the processing of step S201, and in a case where it determines that the optical member 204c has not been inserted into the optical path, it executes the processing of step S5.

The processing of steps S3 to S11 is the same as the processing described in the first embodiment, so a description thereof will be omitted.

In step S201, the determining unit 206 determines whether a preset value has been set. In a case where the determining unit 206 determines that the preset value has been set, it executes the processing of step S202, and in a case where it determines that the preset value has not been set, it executes the processing of step S207.

In step S202, the determining unit 206 determines whether the set preset value is the preset value Pri1. In a case where the determining unit 206 determines that the set preset value is preset value Pri1, it executes processing in step S203; otherwise, it executes processing in step S204.

In step S203, the determining unit 206 acquires a value Pri1Fno, which is the limited Fno corresponding to preset value Pri1, from limited Fno data 214b, and sets the value Pri1Fno to the limited Fno.

In step S204, the determining unit 206 determines whether the set preset value is preset value Pri2. In a case where the determining unit 206 determines that the set preset value is preset value Pri2, it executes processing in step S205; otherwise, it executes processing in step S206.

In step S205, the determining unit 206 acquires a value Pri2Fno, which is the limited Fno corresponding to the preset value Pri2, from the limited Fno data 214b, and sets the value Pri2Fno as the limited Fno.

In step S206, the determining unit 206 acquires a value Pri3Fno, which is the limited Fno corresponding to the preset value Pri3, from the limited Fno data 214b, and sets the value Pri3Fno as the limited Fno.

In step S207, the determining unit 206 sets the limited Fno to a value (default value) that has been previously set in the lens 200.

As described above, with the configuration according to this embodiment, the controllable range of the iris 203 can be changed by the user. In this embodiment, the limited Fno corresponding to the preset value stored in ROM 214 is read and obtained from limited Fno data 214b. Alternatively, an equation may be created using the preset value as a variable and the limited Fno may be calculated.

### Third Embodiment

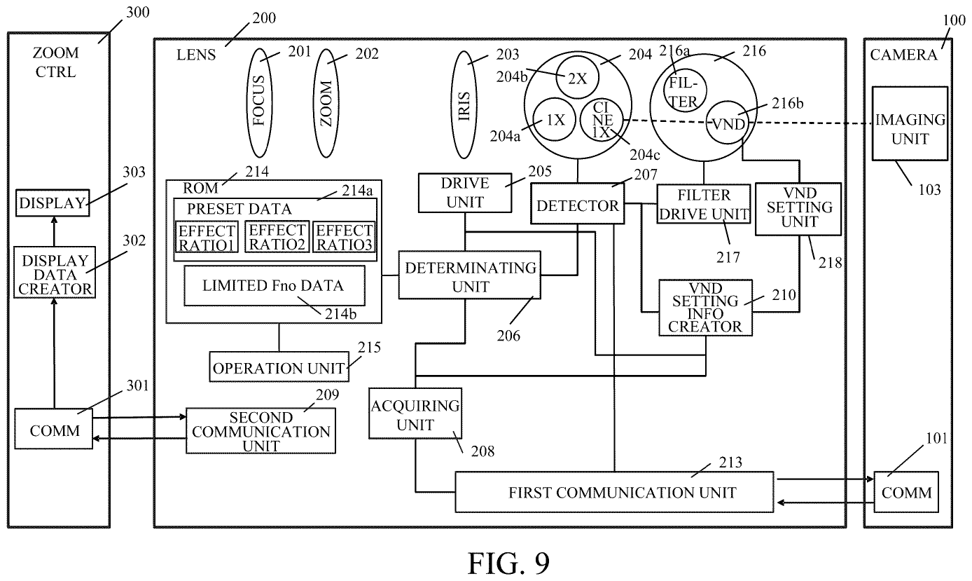

FIG. 9 illustrates the configuration of an imaging system according to this embodiment. This embodiment will discuss only the configuration different from that of the first embodiment, and will omit a description of the common configuration.

In addition to the configuration according to the second embodiment, the lens 200 according to this embodiment further includes a filter disk 216, a filter drive unit 217, and a VND setting unit 218. The filter disk 216 includes a filter 216a and a VND 216b. The filter drive unit 217 drives the filter disk 216 to insert either the filter 216a or the VND 216b into the optical path. The filter 216a may have no optical member, allowing light to pass through as it is, or may have an optical member. In the following description, the filter 216a is assumed to have no optical member, allowing light to pass through as it is. Since the lens 200 includes the VND 216b, it does not need to have the light amount confirming unit 211 or VND information acquiring unit 212. The VND setting unit 218 sets the setting value for the VND 216b created by the VND setting information creator 210.

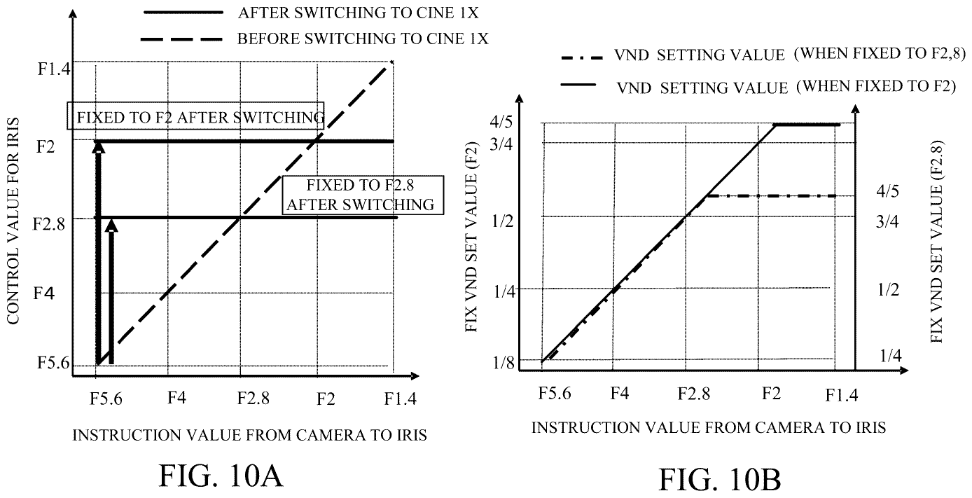

FIGS. 10A and 10B illustrate a control value for the iris 203 and the setting value for the VND 216b in a case where the optical member 204c is inserted into the optical path.

FIG. 10A illustrates the control value of iris 203 in a case where the optical member 204c is inserted into the optical path. A horizontal axis represents an instruction value for the iris 203 from the camera 100, and a vertical axis represents a control value for the iris 203. Before the optical member 204c is inserted into the optical path, the control value for iris 203 is set to the instruction value for iris 203 from camera 100. After the optical member 204c is inserted into the optical path, the control value for the iris 203 is set to the fixed values (F2 and F2.8 in this example). The fixed values correspond to the limited Fno in the first and second embodiments.

FIG. 10B illustrates the setting value of VND 216b when the optical member 204c is inserted into the optical path. A horizontal axis represents the instruction value for the iris 203 from the camera 100, and a vertical axis represents the setting value for VND 216b. In a case where the optical member 204c is inserted into the optical path, the filter 216a is removed from the optical path, the VND 216b is inserted into the optical path, and the exposure is adjusted by changing the setting value for the VND 216b. FIG. 10B illustrates the setting value for the VND 216b in a case where the optical member 204c is inserted into the optical path and the control value for the iris 203 is fixed at F2, and the setting value for VND 216b in a case where the control value for the iris 203 is fixed at F2.8. A left vertical axis illustrates the setting value for VND 216b in a case where the control value is fixed at F2, and the right vertical axis illustrates the setting value for VND 216b in a case where the control value is fixed at F2.8. This is an example where the minimum value of the attenuation rate of the VND 216 b is ⅘.

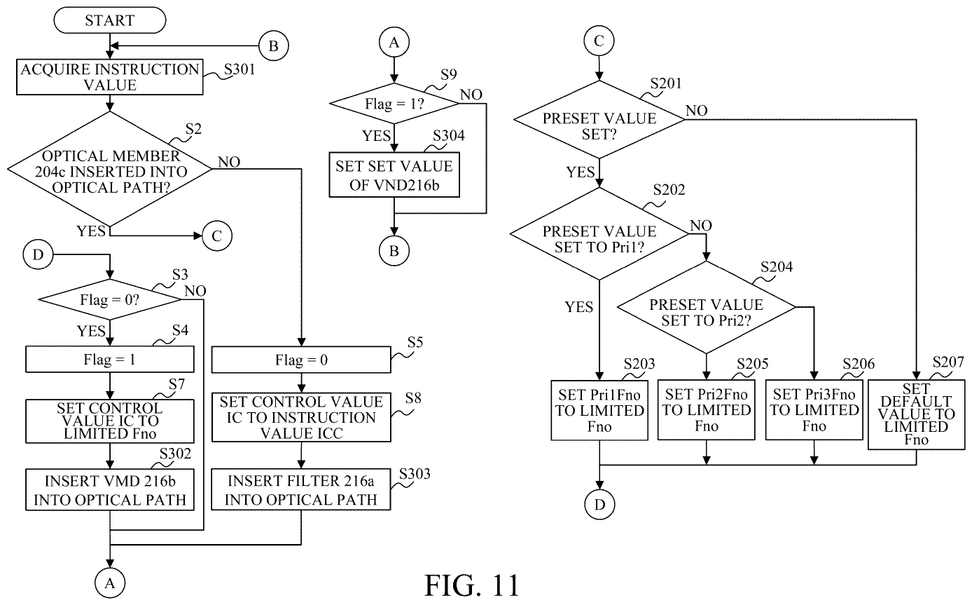

FIG. 11 is a flowchart illustrating the processing of the determining unit 206 and VND setting section 218 according to this embodiment.

In step S301, the determining unit 206 acquires an instruction value for the iris 203 in the camera 100.

The processing of steps S2 to S5 and steps S7 to S9 is the same as the processing described in the first embodiment, so a description thereof will be omitted.

In step S302, the VND setting information creator 210 inserts the VND 216b into the optical path via the filter drive unit 217.

In step S303, the VND setting information creator 210 inserts the filter 216a into the optical path via the filter drive unit 217.

In step S304, the VND setting information creator 210 sets the setting value for the VND 216b via the VND setting unit 218.

The processing in steps S201 to S207 is similar to the processing described in the second embodiment, and thus a description thereof will be omitted.

As described above, in a case where the optical member 204c is inserted into the optical path, the configuration according to this embodiment can set the control value of the iris 203 to a fixed value, thereby maintaining a constant effect ratio and enabling continuous exposure adjustment by the VND 216b.

### Fourth Embodiment

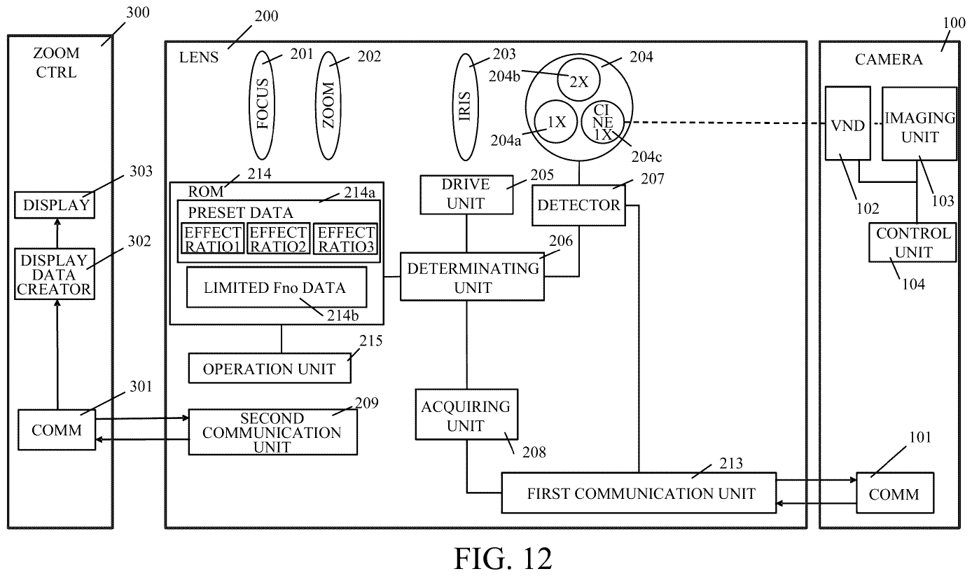

FIG. 12 illustrates the configuration of an imaging system according to this embodiment. This embodiment will discuss only the configuration different from that of the first embodiment, and will omit a description of the common configuration.

The lens 200 according to this embodiment differs from the configuration of the third embodiment in that it does not include the VND setting information creator 210, filter disk 216, filter drive unit 217, or VND setting unit 218. As with the third embodiment, before the optical member 204c is inserted into the optical path, the control value of the iris 203 is set to the instruction value for the iris 203 from the camera 100. After the optical member 204c is inserted into the optical path, the control value for the iris 203 is set to a fixed value (limited Fno).

The camera 100 according to this embodiment includes a control unit 104 that controls the entire imaging system.

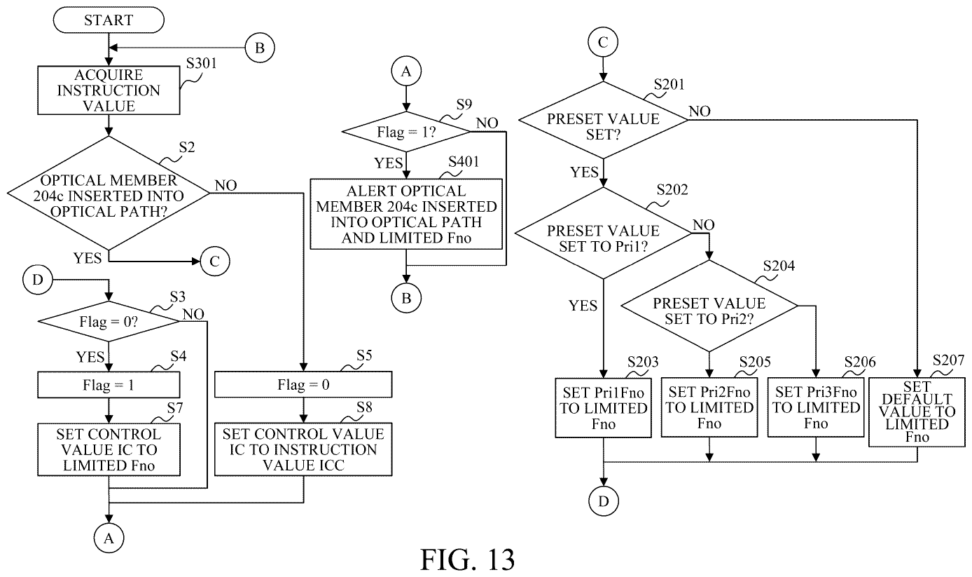

FIG. 13 is a flowchart illustrating processing of the lens 200 according to this embodiment.

The processing of step S301 is similar to the processing described in the third embodiment, so a description thereof will be omitted.

The processing of steps S2 to S5 and steps S7 to S9 is similar to the processing described in the first embodiment, so a description thereof will be omitted.

The processing of steps S201 to S207 is similar to the processing described in the second embodiment, and thus a description thereof will be omitted.

In step S401, the determining unit 206 alerts the camera 100 via the first communication unit 213 and the communication unit 101 to the insertion of the optical member 204c into the optical path and the limited Fno.

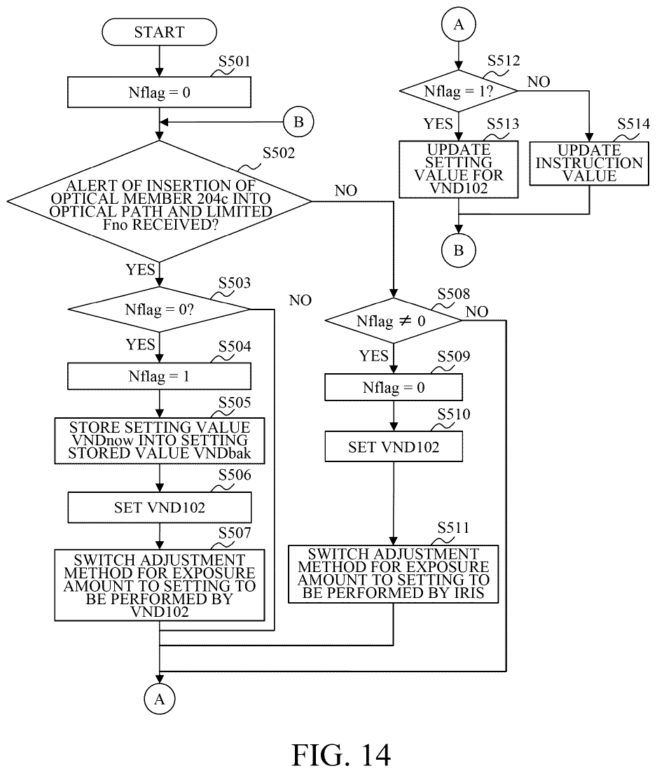

FIG. 14 is a flowchart illustrating processing of the camera 100 according to this embodiment.

In step S501, the control unit 104 sets a discrimination flag Nflag to 0 to confirm whether this is the first time that it has received the alert of the insertion of the optical member 204c and the limited Fno. The control unit 104 also performs initial settings such that the setting stored value VNDbak for the VND 102 is the current setting value VNDnow, and that exposure adjustment is to be performed by the iris 203.

In step S502, the control unit 104 determines whether it has received the alert from the lens 200 of the insertion of the optical member 204c and the limited Fno. In a case where the control unit 104 determines that it has received the alert, it executes processing in step S503; if it determines that it has not received an alert, it executes processing in step S508.

In step S503, the control unit 104 determines whether the determination flag Nflag is 0. In a case where the control unit 104 determines that the determination flag Nflag is 0, it executes processing in step S504; otherwise, it executes processing in step S508.

In step S504, the control unit 104 sets the determination flag Nflag to 1.

In step S505, the control unit 104 saves the setting value VNDnow for the VND 102 in the setting stored value VNDbak.

In step S506, the control unit 104 sets in the VND 102 a setting value for the VND 102 that makes the light amount equal between the instruction value for the iris 203 from the camera 100 and the limited Fno alerted by the lens 200.

In step S507, the control unit 104 switches the exposure adjustment method to the setting (second method) to be performed by the VND 102.

In step S508, the control unit 104 determines whether the determination flag Nflag is not 0. In a case where the control unit 104 determines that the determination flag Nflag is not 0, it executes processing in step S509, and if it determines that the determination flag is not 0, it executes processing in step S512.

In step S509, the control unit 104 sets the determination flag Nflag to 0.

In step S510, the control unit 104 sets the setting stored value VNDbak to the VND 102.

In step S511, control unit 104 switches the exposure adjustment method to the setting (first method) to be performed by the iris provided in camera 100.

In step S512, control unit 104 determines whether determination flag Nflag is 1. In a case where control unit 104 determines that determination flag Nflag is 1, it executes processing in step S513, and if it determines that Nflag is not 1, it executes processing in step S514.

In step S513, control unit 104 updates the setting value for the VND 102.

In step S514, control unit 104 updates the instruction value for the iris 203 in the camera 100.

As described above, in the configuration according to this embodiment, the lens 200 notifies the camera 100 that optical member 204c has been inserted into the optical path, and enables the exposure adjustment method to be freely set within the camera 100, and a proper operation for the imaging system.

In this embodiment, the control value for the iris 203 is fixed in the lens 200, but the instruction value for the iris 203 from the camera 100 may also be fixed.

The effect ratio is saved in the preset data 214a in the lens 200 and fixed at the corresponding limited Fno, but the preset data for the control value of the iris 203 may be saved in the camera 100 and the instruction value for the iris 203 may be fixed to that value.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide a lens apparatus that can properly perform processing in a case where an optical member that changes aberration is used.

This application claims the benefit of Japanese Patent Application No. 2024-217642, filed on Dec. 12, 2024, and which is hereby incorporated by reference herein in its entirety.

What is claimed is:

1. An optical apparatus attachable to and detachable from an image pickup apparatus, the optical apparatus comprising:
an aperture stop configured to change an aperture value;
a first optical member configured to change an aberration by being inserted into and removed from an optical path;
one or more memories storing instructions; and
one or more processors that, upon execution of the instructions, operate to perform processing regarding the aperture stop in accordance with a first aperture value that limits a variable range of the aperture value, and a second aperture value transmitted from the image pickup apparatus,
wherein the first aperture value is determined based on an optical characteristic of the first optical member.

2. The optical apparatus according to claim 1, wherein the one or more processors operate to:
set an aperture value for the aperture stop to the second aperture value in a case where the second aperture value is smaller than the first aperture value, and
set the aperture value for the aperture stop to the first aperture value in a case where the second aperture value is greater than the first aperture value.

3. The optical apparatus according to claim 1, wherein in a case where the second aperture value is greater than the first aperture value, the one or more processors operate to transmit information on the first aperture value to an external device.

4. The optical apparatus according to claim 3, wherein the external device is at least one of the image pickup apparatus and an operation apparatus configured to operate the optical apparatus.

5. The optical apparatus according to claim 1,
wherein in a case where the second aperture value is greater than the first aperture value at a first timing, the one or more processors operate to notify information on exposure amount adjustment, and
wherein the information on exposure amount adjustment is used to make an exposure amount of the image pickup apparatus at the first timing equal to an exposure amount of the image pickup apparatus at a second timing prior to the first timing.

6. The optical apparatus according to claim 5, wherein the information on the exposure amount adjustment includes at least one of information on an aperture stop provided in the image pickup apparatus, information on a variable ND filter provided in the image pickup apparatus, information on an image gain, and information on a shutter speed.

7. The optical apparatus according to claim 1, wherein the optical system further includes a variable ND filter, and
wherein in a case where the second aperture value is greater than the first aperture value at a first timing, the one or more processors operate to calculate and set information on the variable ND filter so as to make an exposure amount of the image pickup apparatus at the first timing equal to an exposure amount of the image pickup apparatus at a second timing prior to the first timing.

8. The optical apparatus according to claim 1, wherein the optical system further includes:
a driven unit that includes a plurality of optical members including the first optical member, and
a drive unit configured to drive the driven unit so that each of the plurality of optical members is inserted into or removed from an optical path,
wherein in a case where the first optical member is inserted into the optical path, the one or more processors operate to perform the processing in accordance with the first and second aperture values.

9. The optical apparatus according to claim 8, wherein the plurality of optical members includes a second optical member configured to change magnification.

10. The optical apparatus according to claim 1, wherein the one or more processors operate to acquire information on an optical characteristic of the first optical member selected by a user and set the second aperture value in accordance with the information.

11. The optical apparatus according to claim 1, wherein the aberration includes at least one of spherical aberration and chromatic aberration.

12. An image pickup apparatus attachable to and detachable from an optical apparatus that includes an aperture stop and a first optical member configured to change an aberration, the image pickup apparatus comprising:
an image sensor;
one or more memories storing instructions; and
one or more processors that, upon execution of the instructions, operate to:
acquire a first aperture value that defines a movable range of the aperture stop, which is determined based on an optical characteristic of the first optical member, and
adjust an exposure amount to the image sensor,
wherein in a case where the first aperture value is acquired, the one or more processors operate to set an aperture value for the aperture stop to the first aperture value, and switch an exposure adjustment method from a first method to a second method.

13. The image pickup apparatus according to claim 12, wherein the optical apparatus includes:
a driven unit that includes a plurality of optical members including the first optical member; and
a drive unit configured to drive the driven unit so that each of the plurality of optical members is inserted into or removed from an optical path;
wherein in a case where the first optical member is inserted into the optical path, the one or more processors operate to acquire information indicating that the first optical member has been inserted into the optical path.

14. The image pickup apparatus according to claim 12, wherein the first method uses an aperture stop provided in the image pickup apparatus;
wherein the second method uses at least one of a variable ND filter, an image gain, and a shutter speed provided in the image pickup apparatus.

15. An imaging system comprising:
the optical apparatus according to claim 1;
the image pickup apparatus that includes the image sensor.

16. An imaging system comprising:
the image pickup apparatus according to claim 12; and
the optical apparatus that includes the aperture stop and the first optical member.
